(19) United States
(12) Patent Application Publication
(10) Pub. No.: US 2012/0282581 A1
(43) Pub. Date: Nov. 8, 2012

(54) SYSTEM AND METHOD FOR BEHAVIOR MODIFICATION

(76) Inventor: Susan Isenberg, Florissant, MO (US)

(21) Appl. No.: 13/526,384

(22) Filed: Jun. 18, 2012

Related U.S. Application Data
(63) Continuation of application No. 10/107,872, filed on Mar. 27, 2002, now abandoned.

(51) Int. Cl. G09B 19/00

(52) U.S. Cl. 434/238

(57) ABSTRACT

A method for producing a behavior modification plan is disclosed which comprises the steps of providing a computer system having a program, the program for allowing input of information, inputting information relating to a behavior modification to be made, inputting information relating to past successes in the behavior modification to be made, inputting information relating to prior and anticipated barriers in the behavior modification to be made, inputting information relating to success in other areas other than the behavior modification to be made, inputting information relating to a preferred learning style, preparing a behavior modification plan based upon the behavior modification to be made, prior barriers, anticipated barriers, and a preferred learning style, and displaying the prepared behavior modification plan. A system for producing a behavior modification plan is also disclosed.

### CROSS REFERENCE TO RELATED APPLICATIONS

This application is a continuation of U.S. patent application Ser. No. 10/107,872 filed on Mar. 27, 2002.

### BACKGROUND

This disclosure relates to a system and method for behavior modification and more particularly to a system and method for preparing a behavior modification plan.

Life expectancy is steadily increasing with advancements in medical technology and improvements in access to health care. However, healthy lifestyle habits continue to be elusive in areas such as stress, weight control, smoking, and exercise. Attempting to make a behavior change to improve ones health is a very difficult task to accomplish. Not only is making a behavior change difficult, but one must be ready to change before success in encountered. This is why many people are not successful at losing weight, quitting smoking, exercising, or managing stress. There is more to making a change than simply wanting to change. For example, if you are overweight, do not exercise, and smoke and you are ready to change to get healthier, you may feel overwhelmed and unwilling to change due to prior failed attempts at changing. The process of how to make a change is the key to success. The process begins with knowing where to start and what to do first. This step-by-step systematic approach helps to achieve the goals for health improvement by building confidence, increasing motivation and providing a tool to carry out change.

There are basically six stages of change that must be moved through in order to be able to successfully make a change. The first stage is precontemplation which means that one is not even thinking about making a change. If quitting smoking is used as an example, then a precontemplator would either not know the health risks of smoking or not think the benefits of quitting smoking outweigh the discomfort of quitting. The second stage is known as the contemplative stage. In this stage one is thinking about quitting smoking in the near term, such as within the next six months. Contemplators know that they want to quit smoking, but they do not have a plan. Contemplators can be stuck in the contemplation stage for years. The preparation stage, the third stage, follows when one is developing a plan to quit, setting a quit date, and gathering the information and supplies needed. In the next stage, the action stage, one is in the process of quitting. In this stage, one is more likely to experience failure, as in the example of smoking, one will begin smoking again. The fifth stage is known as the maintenance stage. The maintenance stage is the period of time when it has been at least six months since the behavior change has been made. Chances are that smoking has not been started, but one has the feeling of being pulled back to smoking because a void is being felt. The sixth and final stage is known as the termination stage. In this stage one is not likely to go back to the old behavior and this usually requires the passage of five years.

One way in which a patient may make a behavior change involves interaction with a doctor and distribution of information or documents describing the health benefits of a patient's behavior modification. However, there are several disadvantages associated with this method. For example, limited information on how to make a lifestyle change may be listed in the brochure. There is also no on-going support to assist the patient is continuing the behavior modification program. Another disadvantage is that the information provided to the patient may be lacking. Although doctors or health care providers are a first line of health coaches, beyond making recommendations concerning what changes to make, most physicians lack the time and resources to coach patients into taking action.

The present disclosure is designed to obviate and overcome many of the disadvantages and shortcomings associated with present systems and methods that are used for behavior modification of individuals. In particular, the present disclosure is a system and method that develops and prepares a behavior modification plan based upon numerous factors associated with each individual. Moreover, the system of the present disclosure can be employed to determine whether an individual is ready to prepare and participate in a behavior modification plan.

The system and method of preparing a behavior modification plan will put an individual in control, allow an individual to begin where the individual is at so that no time is wasted in repetition or performing activities that have no meaning, helps the individual answer the question where do I start, gives the individual a systematic, practical, structured method of achieving goals, and allows the individual to be successful without being perfect. The system and method of preparing a behavior modification plan focuses on behaviors, not outcomes, encourages social support and self-rewards, is flexible and ever-changing as the needs of an individual changes, allows an individual to learn through trial and error what works and what does not work, and also provides for self-paced change.

### SUMMARY

In one form of the present disclosure, a method for producing a behavior modification plan comprises the steps of providing a computer system having a program, the program for allowing input of information, inputting information relating to a behavior modification to be made, inputting information relating to past successes in the behavior modification to be made, inputting information relating to prior and anticipated barriers in the behavior modification to be made, inputting information relating to success in other areas other than the behavior modification to be made, inputting information relating to a preferred learning style, preparing a behavior modification plan based upon the behavior modification to be made, prior barriers, anticipated barriers, and a preferred learning style; and displaying the prepared behavior modification plan.

In another form of the present disclosure, a system for preparing a behavior modification plan comprises a computer having a program, the program for allowing input of information, an input device for inputting information relating to a behavior modification to be made, information relating to past successes in the behavior modification to be made, information relating to prior and anticipated barriers in the behavior modification to be made, information relating to success in other areas other than the behavior modification to be made, and information relating to a preferred learning style, the program for preparing a behavior modification plan based upon the behavior modification to be made, past successes in the behavior modification to be made, prior and anticipated barriers in the behavior modification to be made, success in other areas other than the behavior modification to be made, and a preferred learning style, and a display for displaying the prepared behavior modification plan.

The present disclosure also is a method for producing a behavior modification plan which comprises the steps of providing a computer system having a program, the program for allowing input of information, inputting information relating to behavior modifications to be made and ranking the behavior modifications to be made, inputting information relating to prior barriers in the behavior modifications to be made, inputting information relating to whether prior barriers in the behavior modifications to be made still exist, inputting information relating to success in other areas other than the behavior modifications to be made, inputting information relating to a preferred learning style, preparing a behavior modification plan based upon the behavior modifications to be made, still existing prior barriers, success in other areas other than the behavior modifications to be made, and a preferred learning style, and displaying the prepared behavior modification plan.

In still another form of the present disclosure, a system for preparing a behavior modification plan is disclosed which comprises a computer having a program, the program for allowing input of information, an input device for inputting information relating to behavior modifications to be made and ranking the behavior modifications to be made, information relating to past successes in the behavior modifications to be made, information relating to prior and anticipated barriers in the behavior modifications to be made, information relating to success in other areas other than the behavior modifications to be made, and information relating to a preferred learning style, the program for preparing a behavior modification plan based upon the behavior modifications to be made, past successes in the behavior modifications to be made, prior and anticipated barriers in the behavior modifications to be made, success in other areas other than the behavior modifications to be made, and a preferred learning style, and a display for displaying the prepared behavior modification plan.

In light of the foregoing comments, it will be recognized that the present disclosure is directed to providing a system and method for preparing a behavior modification plan.

The present disclosure provides a system and method for building confidence, motivation, and providing a plan to succeed in making a behavior change to improve health.

The present disclosure provides a system and method of preparing a behavior modification plan that enhances an individual's compliance with the plan.

The present disclosure provides a system and method for preparing a behavior modification plan that determines prior successes and prior and anticipated barriers in being successful.

The present disclosure provides a system and method for preparing a behavior modification plan based upon prior successes unrelated to a behavior modification to be made.

The present disclosure also provides a system and method of preparing a behavior modification plan that determines an individual's preferred learning method or style.

The present disclosure further provides a system and method of preparing a behavior modification plan based upon a prioritized behavior modification to be made.

The system and method of preparing a behavior modification plan of the present disclosure builds confidence by helping an individual identify other times in which the individual has been successful in other ways, encourages an individual to identify reasons why change has not been made in the past, why success may not be encountered this time, and ways to get around those barriers. The system and method of the present disclosure also determines or reveals an individual's favorite manner in which to learn new material or information. Making a behavior change requires learning something new. The system and method of the present disclosure also determines why a change is required and why such change was not previously made. The system and method of the present disclosure is also capable of creating or preparing a behavior change plan which answers questions such as what will an individual do to change, how will an individual do the change, how will an individual know that the change has happened, who will support an individual in changing, and how will an individual be rewarded. The system and method of the present disclosure may be used by high risk patients or individuals, those with several modifiable risk factors, who have a history of failure in past attempts to make healthy lifestyle changes, lack confidence and motivation, may feel overwhelmed, and are unsure of where or how to start.

The system and method of the present disclosure may include a software program having three basic sections. The first section addresses the psychology of change by promoting reflective thinking. This section may have five components which include the science and theory behind health coaching, learning from the past, determining priorities, addressing barriers, and knowing your preferred learning style(s). The second section concerns building the behavior change plan by providing an organized list of things to do based upon answers to the questions who, what, where, when, why, and how. The third section concerns implementing the behavior change plan. A call to action leads a patient or individual to a local listing of health promotion resources such as expert advisors, programs, printed material, websites, etc. The software program may also include an animated figure, such as a coach, which interacts audibly with the individual. The animatedure tailors the coaching based on the patient's answers to certain questions presented by the program.

These and other advantages of the present disclosure of a system and method for behavior modification will become apparent after considering the following detailed specification in conjunction with the accompanying drawings, wherein:

### BRIEF DESCRIPTION OF THE DRAWINGS

FIG. 1 is a block diagram of a system for preparing a behavior modification plan constructed according to the present disclosure;

FIG. 2 is a flow chart diagram illustrating the operation of the system for preparing a behavior modification constructed according to the present disclosure;

FIG. 3 is an illustration of a screen which may be presented during use of the system for preparing a behavior modification plan;

FIG. 4 is an illustration of a screen which may be presented during use of the system for preparing a behavior modification plan;

FIG. 5 is another illustration of a screen which may be presented during use of the system for preparing a behavior modification plan;

FIG. 6 is an illustration of a screen which may be presented during use of the system for preparing a behavior modification plan;

FIG. 7 is an illustration of a first page of a behavior modification plan;

FIG. 8 is an illustration of a second page of a behavior modification plan;

FIG. 9 is an illustration of a third page of a behavior modification plan;

FIG. 10 is an illustration of a fourth page of a behavior modification plan;

FIG. 11 is an illustration of a fifth page of a behavior modification plan;

FIG. 12 is an illustration of a sixth page of a behavior modification plan; and

FIG. 13 is a block diagram of another preferred embodiment of a system for preparing a behavior modification plan constructed according to the present disclosure.

### DETAILED DESCRIPTION OF THE PREFERRED EMBODIMENTS

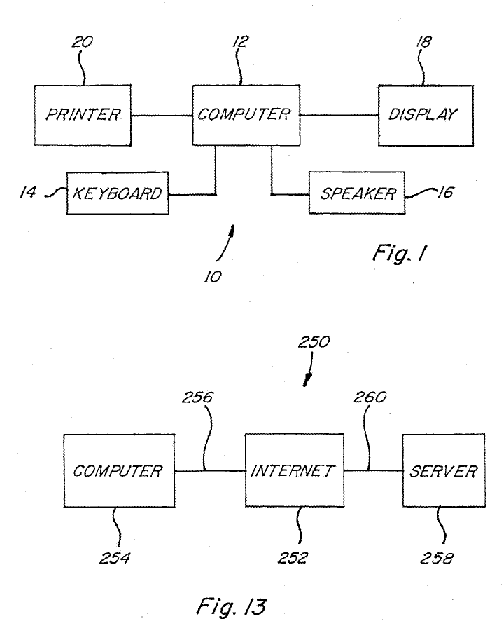

Referring now to the drawings, wherein like numbers refer to like items, number 10 identifies a preferred embodiment of a system for preparing a behavior modification plan constructed according to the present disclosure. With reference now to FIG. 1, the system 10 is shown to comprise a computer 12 having peripheral devices connected thereto, such as a keyboard 14, a speaker 16, a display 18, and a printer 20. The computer 12 may be a personal computer having a microprocessor, memory, a hard drive having stored thereon an operating system and other software, and input devices such as a mouse, a CD-ROM drive, or a floppy disk drive. An example of other software may be a software program which prepares a behavior modification plan based upon a patient's interaction with the program and the computer 12. Further, it is also possible and contemplated that the program may be stored on a CD-ROM. The program will be discussed more fully herein. The keyboard 14 is used to input information and the mouse may be used to select or click on icons presented on the display 18. The speaker 16 is used to hear information provided from the computer 12. Additionally, the printer 20 will be used to print out a plan, as will be explained further herein.

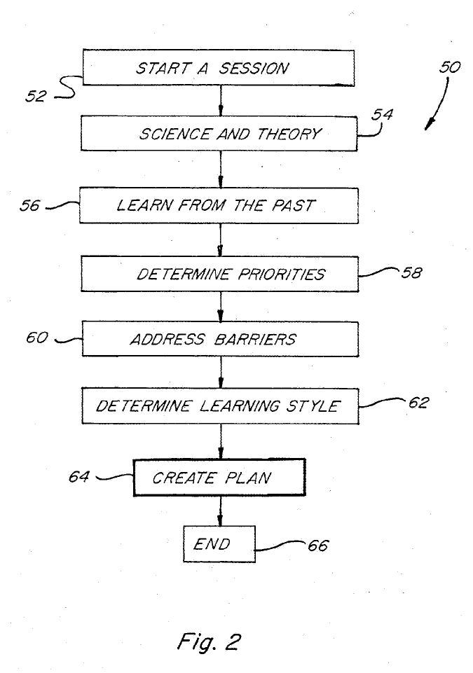

FIG. 2 is a flow chart 50 of the general operation of the system 10 or the program for producing a behavior modification plan. It is to be assumed that either the software program is on a CD-ROM or has been loaded on the hard drive of the computer 12. As an initial step 52, a user of the system 10 starts a session by reviewing information about the system 10. After the information is reviewed, a step 54 is encountered in which the science and theory behind behavior modification is reviewed for a user. For example, various screens may be presented on the display 18 which detail why it is difficult to begin a behavior modification. After all of the screens are displayed, in a next step 56, it is determined whether a user has had any problems or barriers in the past when attempting to make a lifestyle change. A series of screens may be presented on the display 18 in which questions need to be answered concerning any past problems. Other screens may be presented to determine any past successes. Once these questions are answered or all of the screens have been presented, a next step 58 is encountered in which priorities are ranked. Such priorities may include whether a change in weight is desired, stress management is desired, quitting smoking is desired, or another type of lifestyle change is desired. After the priorities have been ranked, it is determined whether there have been any barriers in the past and what barriers are anticipated in the future in making a behavior modification. This is accomplished in a step 60. Once the barriers have been identified, a user's learning style is developed. This occurs in a step 62 in which it is determined if the user learns better using various styles such as print, aural, visual, haptic, kinesthetic, or olfactory. Based upon the various previous responses, a behavior modification plan is prepared in a step 64. The system 10 may then end operation in a step 66.

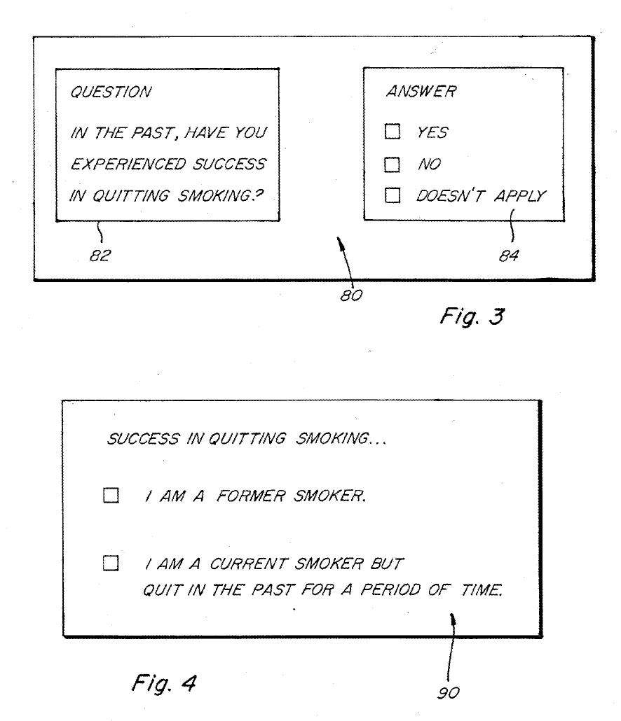

In determining past experiences, such as a past history of failure in attempts to make lifestyle changes like quitting smoking, losing weight, exercising, etc., the system 10 presents various screens to an individual. With reference now to FIG. 3, there is illustrated a screen 80 which presents a question box 82 concerning past success in quitting smoking. An answer box 84 is also presented in which an individual is required to select the most appropriate answer. If the answer selected is yes, then the program will proceed to a next screen 90, FIG. 4, to determine what success there was in quitting smoking in the past. Depending upon the answer selected in the screen 90, the program will interact with the user through animation and audio to provide encouragement or provide suggestions on quitting. The program also asks questions concerning losing weight, amount of exercise, eating habits, managing stress, and controlling drinking. The program further determines if the individual has had success in the past in other areas. Such areas include success in building and keeping meaningful relationships, success in parenting children, success in learning new things, success in a profession, job, or business, success in creative activities such as music, art, writing, or dancing, success in community activity involvement or volunteering, and success in caring for or helping others.

FIG. 5 illustrates a screen 100 in which an individual will be asked to list by highest priority which change in behavior is desired. In the screen 100 there are three priority boxes 102, 104, and 106 in which an individual may select which behavior change is desired. For example, in box 102, an individual has selected the option of weight management. By using a pull down menu icon 108, one out of a number of listed items may be selected to be placed in the box 102. The box 104 shows that the option of regular exercise has been selected. Also, the box 106 indicates that no third priority has been selected. Some of the available options in the pull down menus may include quit smoking, weight management, regular exercise, stress management, control over drinking, control over substance use, and safety.

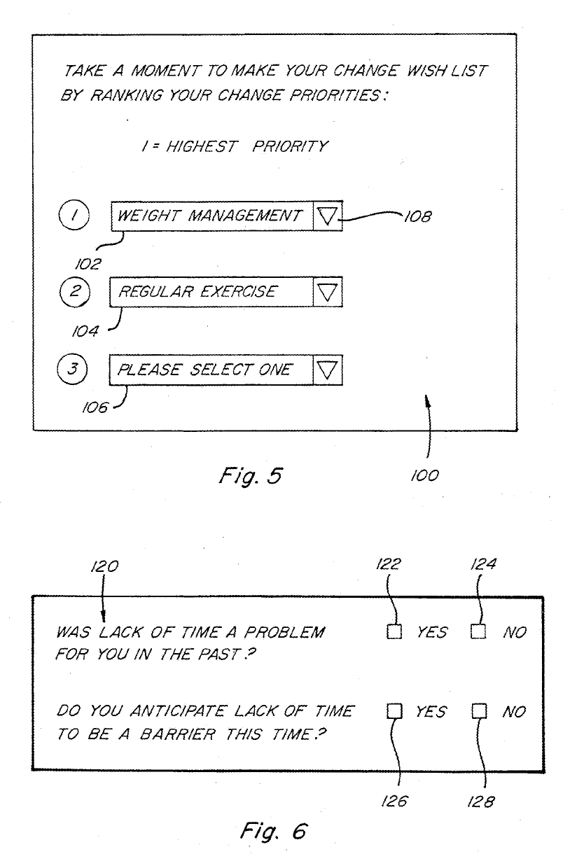

The program further determines whether there have been any barriers in the past and what barriers are anticipated in the future in making a behavior modification. For example, in FIG. 6 there is a screen 120 which questions whether lack of time was a problem in the past and whether lack of time will be a barrier this time. An individual will answer both of these questions by clicking on a yes box 122 or 126 or a no box 124 or 128. Other questions concerning other barriers are presented which may include lack of information, lack of desire, and lack of money.

Implementing a behavior change often requires learning new information. For example, understanding the Food Guide Pyramid helps in learning how to eat healthy, learning assertive communication skills assists in decreasing levels of stress, and learning how to take a pulse helps in determining the intensity of exercise. Different people learn best in different ways. How one learns describes the way one can find out about and deal with ideas and situations in life. All of the senses are used to collect information about the world. Some of the senses dominate the others. A learning style inventory can assess the learning style for an individual and determine the best learning style. Determining how an individual learns best can aid in improving the chances of success in making a behavior change.

In determining how an individual learns best, the program asks an individual user a series of questions by presenting various screens which require a response to the series of questions. These questions are used to determine the best learning style for an individual. Such learning styles include print, aural, interactive, visual, haptic, kinesthetic, and olfactory. Based upon responses to the following questions, the program uses this information in preparing a behavior modification plan. If an individual is print-oriented and often learns best through reading and writing, then the individual will answer yes to the following questions: I remember quickly and easily what I read and I can learn something better after seeing it or after writing it. If an individual is not print oriented, then the individual will probably answer yes to the following questions: I have to read articles several times before grasping the important concepts and the words on the page all seem to run together. If a person answers some of the above-noted questions affirmatively, then the person may have mixed preference for print-oriented learning. Reading and writing may be one way to learn new information.

If an individual is aurally oriented then the person learns best through listening. If an individual learns best when the information is presented verbally due to remembering what is said, then the individual will answer affirmatively to the following questions: I tend to remember and repeat the ideas I hear verbally and I “hear” what others are telling me. On the other hand, if a person does not respond to listening, then the person will answer the following questions in the negative: I find it difficult to remember information presented in lectures and audio tapes leave me wanting to read the information. If the person answers some of these questions yes, then listening may be one strategy for learning.

An individual may learn best by being interactive. Individuals who learn best through verbalization are interactive learners. Such individuals enjoy talking and discussing ideas with other people. Small group discussions or the give and take of debate activities are a few means through which such individuals learn. A classroom situation or a support group may be beneficial. If a person answers yes to the following questions, then this person may learn best by being interactive: I like to use other people as sounding boards and I enjoy question/answer sessions or small group discussions. Further, if a person does not prefer to talk and discuss ideas with other people, then learning from talking and discussing would not appeal to this person as a learning tool. Such a person would answer yes to the following questions: I find that I do not get much information from small/group discussion activities and I would prefer not to discuss things with others, preferring instead to work alone. A mixed response to the above questions would indicate that a person may learn from talking and discussing ideas with other people, but this is not a strong preference.

A person may learn best through observation. Such a person likes to see visual stimuli such as pictures, slides, graphs, tables, demonstrations, etc. If a person is visual, then this person will answer in the affirmative to the following posed questions: I need to have a “picture” in my mind before comprehending something, I “see” what others are trying to tell me, and I create visual images as I think. On the other hand, an answer of no to the following questions will indicate that visual stimuli are not a preferred method of learning: Visual representations such as graphs or tables leave me wanting an explanation, I find it difficult to picture things in my mind, and I fail to understand displays or charts. A mixture of answers to the above questions will lead to the conclusion that the individual may have mixed feelings about learning using visual techniques or stimuli.

Haptic learning style is for individuals who have to feel objects or touch as many items as possible to learn. Individuals who learn best through the sense of touch means that they assimilate information through a hands on approach. A person who has a preference for haptic learning style will answer yes to the following series of questions: I feel that I have to touch the new things that I am learning and “Hands on” experiences are important to me. If a person is not haptic then the answers to the following questions will be no: I find it difficult to distinguish the feel of different items and touching objects des not create a visual image for me. Mixed responses to these questions will indicate that the person may benefit from a hands on approach, but it may not be a strong learning style or preference.

A person who is kinesthetically oriented learns best while moving. Such a person generally has to move around or have to move some part of their body while processing information. A kinesthetically oriented person will be in constant motion, such as tapping a toe, while reading or listening. A kinesthetically oriented person will benefit from reading while on a stationary bike or discussing an issue with someone while taking a walk together. Ideas or decisions may be made while being busy moving around. A person who is kinesthetically oriented will probably answer yes to the following questions: I think I learn better when I am able to move during my learning and I like to move my hands (knit, crochet, doodle) while learning, not from boredom, but because it helps me concentrate. A person who is not kinesthetically oriented will most likely answer yes to the following series of questions: I find movement distracting and it is hard to concentrate on learning something if I am also moving or doing something else. Constant motion while learning will not benefit a person who is not kinesthetically oriented. However, mixed responses to the above questions tend to show that there may be some benefit to kinesthetic learning.

A person who learns best through the sense of smell and taste are called an olfactory learner. Information can be vividly associated with a particular smell or taste. Examples of questions, which are used to determine if you are an olfactory learner, are as follows: Smells have special significance for me, I can associate a particular smell with specific past memories, and I am frequently able to identify smells. An individual who does not learn best through the sense of smell and taste will probably answer yes to the following questions: I find smells basically offensive, smells distract from my learning, and I find it hard to distinguish between different smells. Mixed responses indicate that a person may be able to associate some information with a particular smell or taste.

After reviewing all of the responses, which may be entered by clicking an appropriate box in a screen, presented to an individual, the program may determine that an individual may have more than one preferred learning style. In this instance, the program allows an individual to review the preferred learning styles identified and an individual is asked to choose the most preferred learning style. The program will provide choices for how to follow preferred learning styles with the choices becoming a part of the behavior modification plan.

Once a learning style is determined, the program begins to create a behavior modification plan after more questions are asked by prompting or displaying the questions. For example, if it is determined that a weight management plan is desired, then an individual will be prompted to indicate when the individual plans to begin. Such prompts or start time as within one week, within two week, within three weeks, and within four weeks may be displayed for selection by the individual. It is then to be determined how the individual will know that the plan has been carried out. In particular, with respect to a weight management plan, the individual will be asked whether the individual will write about new behaviors and how they worked each day in a journal, or record successful days on a calendar or a daily planner, or share day-to-day challenges and successes with someone who supports the change effort, or mentally make a note of successful days and what made them successful. Further, the individual is capable of typing in tailored responses.

Next, the program will prompt an individual to enter information concerning who will support the individual in attempting behavior modification. Social support may increase your chance of being successful at making a positive behavior change. Some examples of prompts which may be presented include will your spouse support you, will one of your parents or children support you, will you choose a relative or close friend to support you, will a support person be someone from work, will your doctor or other health care professional be your support, or are there others you will turn to for support.

Participants or users of the program will then choose what rewards will be needed for motivation and continuation of the behavior modification plan. A self-reward is one that an individual can give which is of value, can be accomplished immediately, and is not expensive. Some suggestions provided by the program are time to do things an individual enjoys such as reading, gardening, resting, doing absolutely nothing, or a meaningful event such as a massage or a long distance call to a friend, or purchasing a relatively inexpensive item such as a book or a tool. The most important part of a self-reward is following through and receiving the reward. Various screens are presented to the individual to determine what the self-reward will be. If one of the suggestions is selected, for example, purchasing a relatively inexpensive item, then the individual is provided a list of inexpensive items. In particular, some of the inexpensive items may be purchasing an item of clothing, purchasing a book to read, or purchasing supplies for an activity or project.

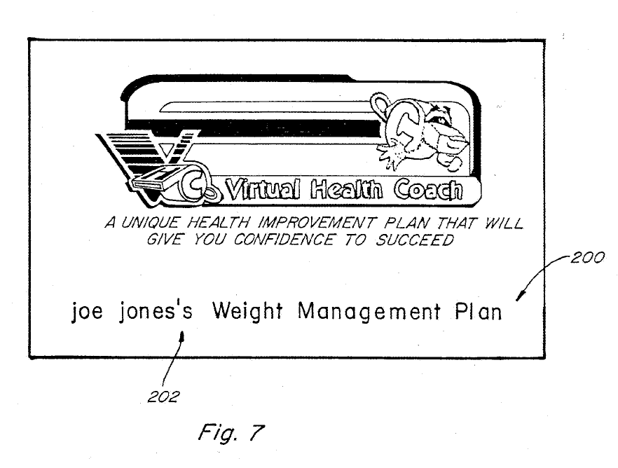

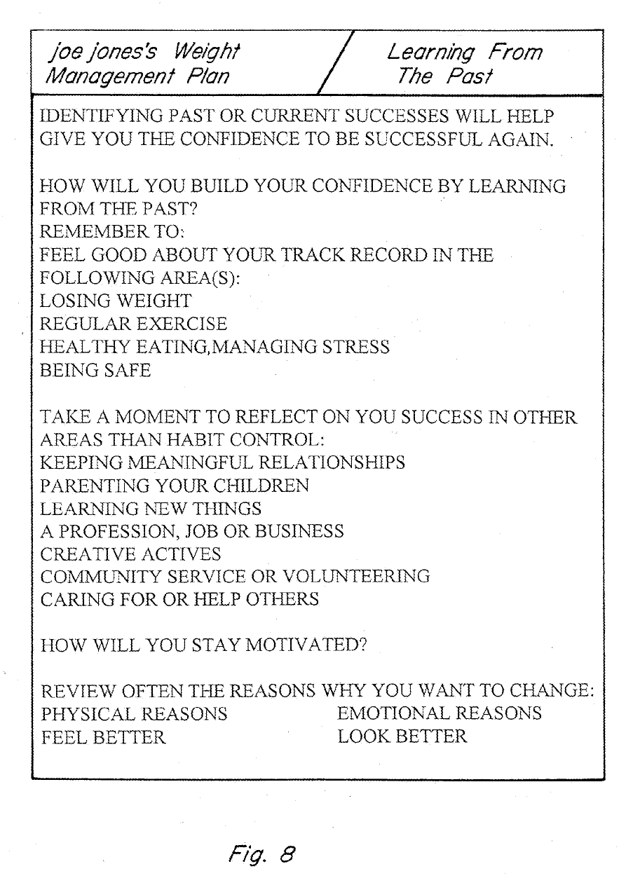

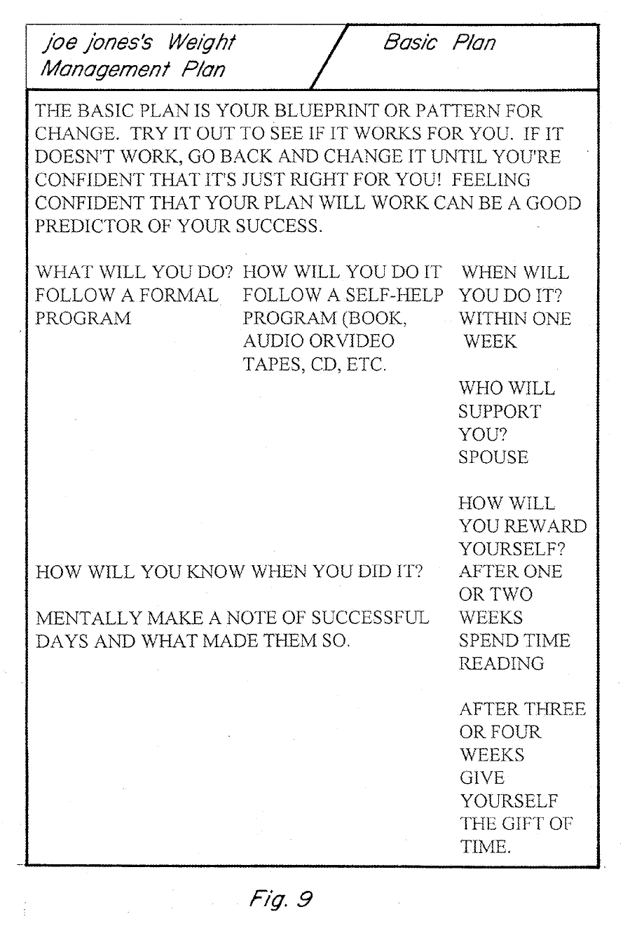

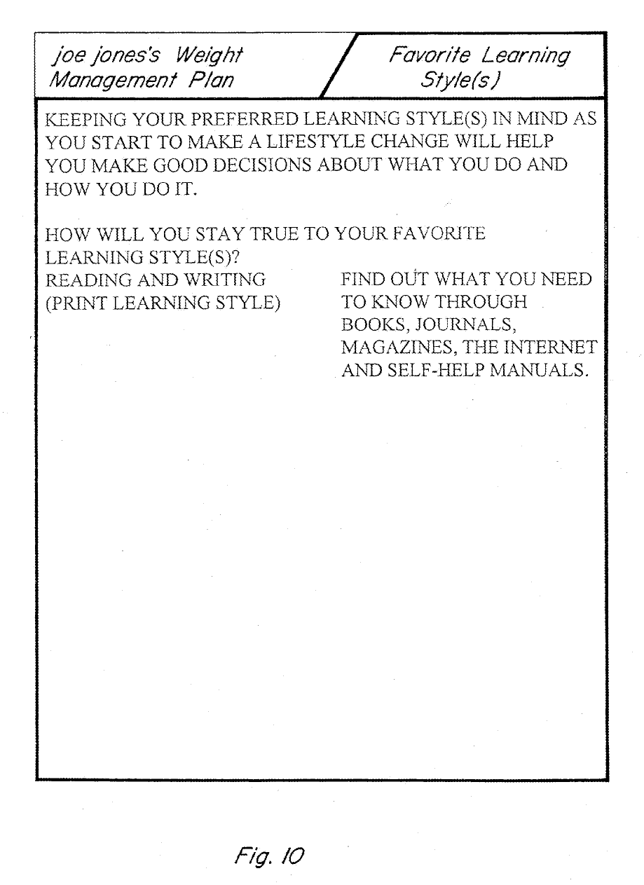

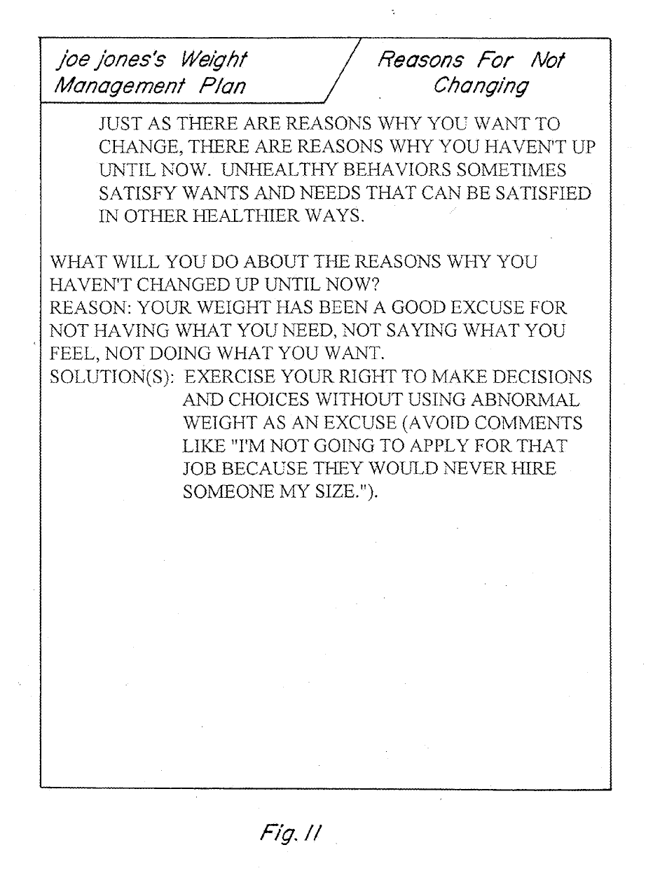

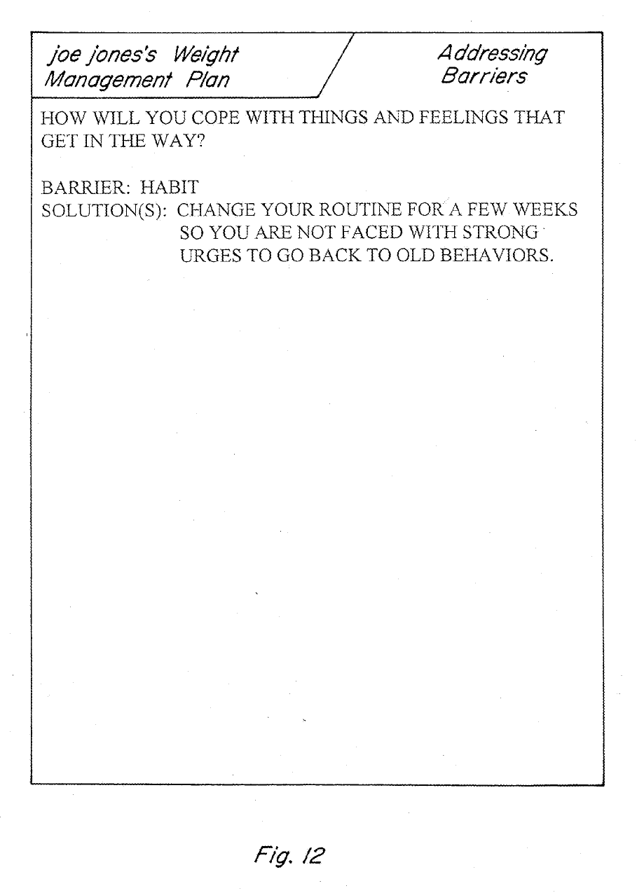

Once all of this information has been entered, the behavior modification plan is created and prepared and the plan is presented on a screen for an individual to view or print. Referring now to FIGS. 7-12, an example of a behavior modification plan 200 is illustrated. This particular behavior modification plan 200 consists of six pages with a first page being shown in FIG. 7. The first page has a title 202 which indicates what behavior modification is being addressed. A second page is illustrated in FIG. 8 and concerns learning from the past. For example, based upon responses, an individual will be reminded how to build confidence by learning from past successes, how to reflect on successes in other areas other than habit control, and how to stay motivated. Turning to a third page, which is depicted in FIG. 9, the basic plan is shown. This plan may consist of what an individual will do, how the individual will accomplish the plan, when the individual will start the plan, how the individual will know what progress is being made, and how the individual will reward himself or herself for remaining on the plan. A fourth page, shown in FIG. 10, identifies a preferred learning style. In this particular plan, print learning style was determined to be the best. The plan 200 provides suggestions on how to learn about weight management. FIG. 11 represents a fifth page of the plan 200. In this fifth page several reasons may be listed for not changing and several suggestions may be listed to avoid or overcome these reasons. In a sixth page of the plan 200, which is shown in FIG. 12, there are listed ways to avoid barriers which might get in the way of making a behavior change. As can be appreciated, depending upon the various responses entered, the plan 200 may be completely different and have numerous other pages, suggestions, and information. The plan 200 shown in FIGS. 7-12 is only one possible illustration.

After the plan has been viewed or printed, it is possible to make changes to the plan. Further, the program automatically saves a behavior change plan for an individual for future review and modification. It is also possible for different users to save different plans or a single user to save one or more different plans. For example, a single user may want to first develop a behavior modification or change plan for weight management and a second behavior modification plan for stress management. The program also provides further information concerning change readiness if needed and what to do with the behavior change plans before allowing an individual to exit from the program. The program may further provide resources to assist an individual to carry out the behavior modification plan. For example, a listing of smoking cessation classes, local exercise facilities, weight management programs may be provided. Other information such as program starting dates, books, tapes, and websites may be provided.

With reference now to FIG. 13, a system 250 is shown, which is implemented over the Internet 252. A computer 254, such as the computer 12, may include a keyboard, a speaker, a display, and a printer, all of which are not illustrated. The computer 254 also has a way or means of being connected to the Internet 252, such as by a telephone line 256, or other means such as cable, ISDN lines, fiber optic lines, wireless connections, or satellites. Through use of the connection to the Internet 252, the computer 254 is capable of accessing a website on a server 258 over a connection 260. The connection 260 may be a telephone line, cable, ISDN lines, fiber optic lines, wireless connections, satellites, or other means of connection. The server 258 may have the program which prepares a behavior modification plan stored thereon. The server 258 is capable of presenting the program to the computer 254 by presenting various screens on the display associated with the computer 254. The computer 254 interacts with the program over the Internet 252 and a behavior modification plan may be printed on the printer associated with the computer 254. As can be appreciated, although the system 250 is shown being connected to the Internet 252, it is also possible and contemplated that the system 250 can be connected in a local area network (LAN) or wide area network (WAN).

From all that has been said, it will be clear that there has thus been shown and described herein a system and method for producing a behavior modification plan which fulfills the various advantages sought therefore. It will become apparent to those skilled in the art, however, that many changes, modifications, variations, and other uses and applications of the subject system and method for producing a behavior modification plan are possible and contemplated. All changes, modifications, variations, and other uses and applications which do not depart from the spirit and scope of the disclosure are deemed to be covered by the disclosure, which is limited only by the claims which follow.

What is claimed is:

1. A method for producing a behavior modification plan comprising the steps of:
providing a computer system having a program, the program for allowing input of information;
inputting information relating to a behavior modification to be made;
inputting information relating to past successes in the behavior modification to be made;
inputting information relating to prior and anticipated barriers in the behavior modification to be made;
inputting information relating to success in other areas other than the behavior modification to be made;
inputting information relating to a preferred learning style;
preparing a behavior modification plan based upon the behavior modification to be made, prior barriers, anticipated barriers, and a preferred learning style; and
displaying the prepared behavior modification plan.

2. The method of claim 1 further comprising the steps of determining how a behavior change will be accomplished, determining when the behavior modification plan will begin, determining a designated support person, and determining a reward.

3. The method of claim 1 wherein the step of inputting information relating to the behavior modification to be made is selected from a listing of possible behavior modifications.

4. The method of claim 1 wherein the step of inputting information relating to a preferred learning style comprises the steps of selecting a preferred learning style from a listing of preferred learning styles.

5. The method of claim 1 wherein the step of inputting information relating to success in other areas other than the behavior modification to be made comprises the step of inputting information relating to relationships, parenting, learning new skills, creative activities, community service, and helping others.

6. The method of claim 1 wherein the step of inputting information relating to prior and anticipated barriers comprises the step of selecting prior and anticipated barriers from a listing of prior and anticipated barriers.

7. The method of claim 1 further comprising the step of saving the prepared behavior modification plan.

8. The method of claim 1 wherein the step of inputting information relating to success in other areas other than the behavior modification to be made comprises the step of selecting from a listing of success in other areas.

9. A computer system for preparing a behavior modification plan comprises:
a computer having a program, the program for allowing input of information;
an input device for inputting information relating to a behavior modification to be made, information relating to past successes in the behavior modification to be made, information relating to prior and anticipated barriers in the behavior modification to be made, information relating to success in other areas other than the behavior modification to be made, and information relating to a preferred learning style;
the program for preparing a behavior modification plan based upon the behavior modification to be made, past successes in the behavior modification to be made, prior and anticipated barriers in the behavior modification to be made, success in other areas other than the behavior modification to be made, and a preferred learning style; and
a display for displaying the prepared behavior modification plan.

10. The system of claim 9 wherein the program is capable of determining how a behavior change will be accomplished, determining when the behavior modification plan will begin, determining a designated support person, and determining a reward.

11. The system of claim 9 wherein the input device for inputting information relating to behavior modifications to be made comprises a keyboard.

12. The system of claim 9 wherein information relating to success in other areas other than the behavior modification to be made comprises inputting information relating to relationships, parenting, learning new skills, creative activities, community service, and helping others.

13. The system of claim 9 further comprising a printer for printing a copy of the prepared behavior modification plan.

14. The system of claim 9 wherein the input device for inputting information relating to prior and anticipated barriers comprises a keyboard.

15. The system of claim 9 wherein information relating to success in other areas other than the behavior modification to be made comprises selecting from a listing of relationships, parenting, learning new skills, creative activities, community service, and helping others.

16. The system of claim 9 wherein the system is capable of preparing a second behavior modification plan to be made based upon inputting information relating to a second behavior modification to be made.

17. A method for producing a behavior modification plan comprising the steps of:
providing a computer system having a program, the program for allowing input of information;
inputting information relating to behavior modifications to be made and ranking the behavior modifications to be made;
inputting information relating to prior barriers in the behavior modifications to be made;
inputting information relating to whether prior barriers in the behavior modifications to be made still exist;
inputting information relating to success in other areas other than the behavior modifications to be made;
inputting information relating to a preferred learning style;
preparing a behavior modification plan based upon the behavior modifications to be made, still existing prior barriers, success in other areas other than the behavior modifications to be made, and a preferred learning style; and
displaying the prepared behavior modification plan.

18. The method of claim 17 wherein the step of inputting information relating to success in other areas other than the behavior modifications to be made comprises the step of inputting information relating to relationships, parenting, learning new skills, creative activities, community service, and helping others

19. The method of claim 17 further comprising the steps of determining how a behavior change will be accomplished, determining when the behavior modification plan will begin, determining a designated support person, and determining a reward.

20. The method of claim 17 further comprising the step of preparing a second behavior modification plan based upon the second ranked behavior modification to be made.
